(19) United States
(12) Patent Application Publication
(10) Pub. No.: US 2026/0099946 A1
(43) Pub. Date: Apr. 9, 2026

(54) METHOD AND SYSTEM FOR DETERMINING THE POSITION AND/OR THE ORIENTATION OF TOOLS OF CONSTRUCTION MACHINES IN A CONSTRUCTION AREA

(71) Applicant: BAUER Maschinen GmbH, Schrobenhausen (DE)

(72) Inventors: Peter BRÜDERLE, Karlskron (DE); Matthias SEMEL, Pfaffenhofen an der Ilm (DE)

(73) Assignee: BAUER Maschinen GmbH, Schrobenhausen (DE)

(21) Appl. No.: 19/353,416

(22) Filed: Oct. 8, 2025

(30) Foreign Application Priority Data
Oct. 9, 2024 (EP) 24205649.7

(51) Int. Cl. G06T 7/73; G06T 17/05; H04N 13/246

(52) U.S. Cl. CPC G06T 7/75; G06T 17/05; H04N 13/246; G06T 2207/10012

(57) ABSTRACT

The invention relates to a method for determining the position and/or orientation of tools of construction machines in a construction area, comprising the steps of: attaching at least one stereo camera to at least one construction machine or to a movable carrier, such that the stereo camera can detect at least one detection region within the construction area, preferably a working region of the construction machine, providing at least one reference point, the position of which is known relative to a predefined 3D world coordinate system and which can be recognised in the images of the stereo camera, in the detection region of the at least one stereo camera, calibrating the at least one stereo camera on the basis of the detection of the at least one reference point and triangulation in order to ascertain a transformation between the 3D world coordinate system and a 2D image coordinate system of the at least one stereo camera, preparing a virtual digital 3D terrain model of the construction area by means of digital image processing, in particular stereoscopy, and image recognition on the basis of the detection of the construction area by means of the at least one stereo camera, and representing predetermined working positions and detected actual tool positions and/or actual tool inclinations of the tool of the at least one construction machine in the virtual digital 3D terrain model.

The invention relates to a method and to a system for determining the position and/or the orientation of tools of construction machines in a construction area.

### PRIOR ART

It is known to determine actual positions of construction machines by means of GPS receivers installed on the respective equipment carriers of the construction machines. Working positions or coordinates within a construction area can be ascertained on this basis by taking into account additional correction data in order to reduce the inaccuracies inherent to determining the position on this basis by GPS receivers alone. The position determination is still always dependent on a GPS signal permanently being received and available and on it being accurate. For example, it is conceivable that receiving GPS or other satellite-based signals becomes restricted or completely blocked in areas of conflict in order to prevent the use of the signals by the parties of the conflict.

In addition, high-accuracy GPS receivers are expensive and the permanent recalculation of positions determined by GPS receivers within the construction area is computationally intensive. This applies all the more if a plurality of construction machines have to be used and positioned in one construction area.

A construction machine can generally be located in a digital terrain model using at least 3 reference points. This can be done, for example, using Bluetooth low energy (BLE) beacons or transmitters, which transmit and receive signals on the basis of Bluetooth technology. To receive the signals from the beacons, permanently installed antenna systems are usually used. Alternatively, however, a smartphone is sufficient. Once the smartphone having the appropriate equipment is located within receiving range of a BLE beacon, the data are read. Once a plurality of receivers are located in a corresponding region, an accurate position of the BLE beacons can be determined. The range of a transmitter is approx. 10-30 metres, but this can be severely restricted by walls or other obstacles.

It is therefore still routine for surveyors to determine and mark positions (e.g. drilling points or starting points) within a construction area. However, this process is also expensive and is dependent on accordingly qualified personnel being available.

US 2022/0 333 355 A1 discloses a method for providing a working guide line for construction machines, wherein the method comprises the following: recognising an object that is located around the construction machinery and capturing an image of the object by means of a 3D camera, which comprises a stereo camera and an object recognition sensor, which can be a RADAR sensor or a LIDAR sensor and can recognise a distance, a direction, etc., by it emitting electromagnetic waves and receiving them again. The method further comprises obtaining a reference coordinate corresponding to a position of the construction machine by means of a position-information receiving device, which can be a GPS, a global navigation satellite system (GLONASS), Galileo or a similar system, ascertaining a relative coordinate of the object relative to the construction machine from the image, coordinate-transforming the relative coordinate based on the reference coordinate to obtain a three-dimensional coordinate, and displaying the image having the three-dimensional coordinate on a screen of the construction machine. By means of the thus obtained three-dimensional coordinate data, it is possible to cooperate with the control apparatus of the construction machine, e.g. for machine steering or machine control.

EP 4 296 436 A1 discloses a system for planning an earth-moving operation to be performed by a construction machine. The system comprises a measuring system configured to capture 3D measurement data of uneven terrain in the surroundings of the construction machine in at least a first detection region, a context camera, which has a known position relative to the measuring system and/or the 3D measurement data and is configured to capture context image data of the terrain within the first detection region, a user interface that is configured such that it displays at least one context image based on the context image data to an operator of the construction machine and receives user inputs from the operator, wherein the user inputs can be interpreted as or comprise a selection of pixels of the context image, and an arithmetic logic unit operatively coupled at least to the measuring system and the user interface. The arithmetic logic unit is configured to generate a 3D terrain model of the terrain within the first detection region on the basis of the 3D measured data, to interpret the user input as a selection of pixels of the context image, to map the selection of pixels to a surface of the 3D terrain model, taking into account the known relative position of the context camera, to determine 3D coordinates on the surface based on the mapping, and to provide the 3D coordinates to the machine control unit, in order to control the earth-moving operation based on the 3D coordinates at least in part.

EP 4 324 988 A1 discloses a method and a system for configuring a machine control unit of a construction machine for controlling an earth-moving operation which has a plurality of phases that are to be performed consecutively, for example for controlling a motor grader or a tracked vehicle for trench or road construction. The system comprises a measuring system comprising at least one measuring unit on the construction machine, wherein each measuring unit is designed to capture 3D point cloud data, i.e. as three-dimensional measured data. Each measuring unit comprises at least one laser scanner, a plurality of time-of-flight (ToF) cameras, a millimetre-wave radar system and/or one or more stereo camera systems. The system further comprises a context camera, which has a known position in relation to the measuring system and/or the three-dimensional measured data and is configured to detect context image data of the terrain within the first detection region. In this case, a user interface is configured to display at least one context image based on the context image data to an operator of the construction machine, an arithmetic logic unit is configured to superimpose recognised elements on the displayed context image and to receive inputs of the operator relating to the next phase of the earth-moving process, and the configuration of the machine control unit is likewise based on the inputs by the operator. Optionally, the user interface can comprise a touch-sensitive display, on which the context image is displayed and on which the user input is received. The input by the operator for the setting can comprise a selection of one or more of the recognised elements.

These systems generally deal with solutions for detecting objects in the immediate working region of a construction machine in question and for displaying them in a digital terrain model relative to the construction machine for a machine operator in order to assist in the operation of the construction machine in question.

A civil engineering device is known from EP 3 553 229 A1 in which, on an upper region of a mast, at least one camera is arranged which can capture an image of the civil engineering device and its surroundings as a measure for visual safety monitoring of a site. By using a plurality of cameras, their images can be linked to corresponding software such that a 360° image of the surroundings is put together from a plurality of camera settings. If a person or an object approaches the civil engineering device and enters a safety region, a warning signal can be output via a control unit in an acoustic, an optical or another manner. In this solution, only the image of the surroundings is recorded as such and is evaluated with a view to a movement of a foreign object.

DE 10 2021 214 441 A1 discloses a method for correcting the ascertaining of an orientation angle of a sensor system of a working machine, which is configured to ascertain orientation angles which display the orientation of a rotatable superstructure of the working machine, wherein at least one camera which detects the surroundings of the working machine is attached to the superstructure.

The invention is based on and, in principle, uses stereoscopic or stereo-vision technology, which is a field of digital image processing that has been subject to research for many years. In this respect, a detailed description of this technology has not been provided in the context of this disclosure. The aim of stereoscopy is to obtain depth information from at least two images which show the same object at the same time from different viewing angles. By means of the perspective differences in the two two-dimensional images, the distance from the imaged object can be calculated. At least two cameras are therefore required for a stereo image. Vision with two cameras is referred to as spatial vision, three-dimensional vision or stereo vision.

If it is to be known where an object point is located in space, the relative position and orientation of the camera relative to a predefined world coordinate system needs to be known. These variables are referred to as extrinsic or external camera parameters. The world coordinate system is determined by means of a known calibration body. The process in which the intrinsic and extrinsic camera parameters are ascertained is called calibration. The aim of the camera calibration is to ascertain the transformation between the 3D world coordinate system and the 2D image coordinate system.

The object addressed by the invention is to provide a method and a system for determining the position and/or orientation of tools of construction machines in a construction area with which the position determination is possible in a cost-effective and accurate manner.

According to the invention, the object is solved both by a method and a system for determining the position and/or orientation of tools of construction machines in a construction area having the features of claim 1 or claim 10, respectively. Preferred embodiments of the invention are set out in the dependent claims.

The method according to the invention is characterised in that it comprises the following steps:
attaching at least one stereo camera to at least one construction machine or to a movable carrier, such that the stereo camera can detect at least one detection region within the construction area, preferably a working region of the construction machine,
providing at least one reference point, the position of which is known relative to a predefined 3D world coordinate system and which can be recognised in the images of the stereo camera, in the detection region of the at least one stereo camera,
calibrating the at least one stereo camera on the basis of the detection of the at least one reference point and triangulation in order to ascertain a transformation between the 3D world coordinate system and a 2D image coordinate system of the at least one stereo camera,
preparing a virtual (digital) 3D terrain model of the construction area by means of digital image processing (stereoscopy) and image recognition on the basis of the detection of the construction area by means of the at least one stereo camera (after the calibration), and
representing predetermined working positions (e.g. target drilling points or starting points) and detected actual tool positions and/or actual tool inclinations of the tool of the at least one construction machine in the virtual 3D terrain model.

One basic concept of the invention is to generate a digital virtual 3D terrain model of a site (of a construction area), and that is on the basis of stereoscopy by means of a stereo camera which detects at least one detection region within the construction area, preferably the working region of a construction machine. For referencing/calibration, at least one reference point is provided and detected by the stereo camera, the exact world coordinates of which are known (e.g. by surveying or GPS receivers). After the calibration, the digital virtual 3D terrain model is prepared on the basis of the images of the construction area detected by the stereo camera.

The 3D terrain model can be continually further updated and improved by further images of the construction area being taken by the stereo camera during the construction operation and being analysed by means of stereoscopy, optionally also in a different orientation of the camera owing to the movement of the construction machine or by using a further stereo camera having a different orientation on the same construction machine or on a further construction machine which is being operated within the same construction area. It is also conceivable to provide the stereo camera on a movable carrier, for example a tripod or stand, which is temporarily set up in a suitable position or in a plurality of different positions within the construction area.

According to the invention, a range of advantages are obtained, namely that expensive GPS equipment is not required for preparing the virtual 3D terrain model, that the 3D terrain model can be used for documenting comparison of target and actual situations (for example as proof of quality or documentation of the construction progress), and/or that the virtual digital 3D terrain model can also be used for positioning the construction machine (or further construction machines) or their tools respectively (optionally also for setting the inclination of a drilling tool) without expensive GPS equipment having to be kept available and operated permanently on each construction machine.

While previous applications of the detection of the site by sensors, including stereo cameras, locate the near field around a working position of a construction machine and directly use the result to assist in the manipulation or control of the construction machine, the present invention aims at that to first prepare a global virtual digital 3D terrain model of the construction area using stereoscopy in order to then move a tool or a construction machine respectively to its production site on the basis of this information plus the current one, further detected information of the stereo camera(s) and to carry out the construction task here while being monitored.

In this case, “monitored” means that, in addition to determining the construction element in relation to a site plan (individual bored pile) on which is currently being worked, further quality-related information is determined, such as the position of the drilling starting point, the orientation of the equipment relative to the borehole (crucial for measuring the verticalness), the orientation of the drill pipe relative to the top edge of the terrain, or also the inclination of a rope grab relative to the slot.

According to the invention, the method can therefore also include positioning and/or orienting the tool of the at least one construction machine (or another construction machine) on the basis of the virtual 3D terrain model in order to bring target and actual values into match.

The accuracy of the virtual digital 3D terrain model can be improved by repeating, for example intermittently or continuously, the detection of the construction area by means of the at least one stereo camera, preferably while its position or orientation is being changed or after it has been changed and has another detection region, and by continually expanding and updating/aligning the virtual 3D terrain model by means of digital image processing (stereoscopy) and image recognition on the basis of the repeated detection of the construction area by means of the at least one stereo camera.

The accuracy of the virtual digital 3D terrain model can also be improved in that at least one further stereo camera being provided which is arranged such that it detects a region of the construction area that is different from the detection region of the at least one stereo camera and preferably the at least one reference point and/or a further reference point, the exact world coordinates of which are known (e.g. by measuring or GPS receivers), that the at least one further stereo camera being calibrated on the basis of the detection of the at least one and/or further reference point and the transformation between the 3D world coordinate system and the 2D image coordinate system of the at least one further stereo camera being ascertained by triangulation. The accuracy of the virtual 3D terrain model of the construction area is then improved by incorporating the detection of the construction area by the at least one further stereo camera in the virtual 3D terrain model of the construction area by digital image processing (stereoscopy) and image recognition.

The accuracy of the virtual digital 3D terrain model can also be improved in that further influencing factors, for example the position of the sun or a wind direction, being ascertained and being taken into account when preparing and/or updating/aligning the virtual digital 3D terrain model.

According to the invention, construction machines can be autonomously two-dimensionally oriented in a construction area without permanently determining the position by means of external signals, such as GPS, etc., by deriving a machine coordinate system of a/the construction machine or a/the tool or a local coordinate system from the virtual 3D terrain model and using the derived machine coordinate system for locally determining the position and/or orientation of the construction machine or the tool within the construction area. The derived machine coordinate system can be loaded into a controller of the construction machine, for example.

Lastly, the method according to the invention can also include aligning a digital site plan of the construction area with the virtual 3D terrain model of the construction area and identifying position deviations. The result of this alignment can be used and stored for the purposes of documenting the working process, for example in the context of quality assurance and proof of quality, and/or can be used for correcting the positioning of a/the tool of a/the construction machine in the ongoing construction process in the event of position deviations.

The invention accordingly also relates to a system for determining the position and/or orientation of tools of construction machines in a construction area, in particular according to the method according to the invention, comprising at least one stereo camera, which is attached to at least one construction machine or to a movable carrier, such that the stereo camera can detect at least one detection region within the construction area, preferably a working region of the construction machine, at least one reference point, the position of which is known relative to a predefined 3D world coordinate system and which can be recognised in the images of the stereo camera, in the detection region of the at least one stereo camera, and an apparatus being configured to carry out the following steps of the method:
calibrating the at least one stereo camera on the basis of the detection of the at least one reference point and triangulation in order to ascertain a transformation between the 3D world coordinate system and a 2D image coordinate system of the at least one stereo camera,
preparing a virtual digital 3D terrain model of the construction area by means of digital image processing, in particular stereoscopy, and image recognition on the basis of the detection of the construction area by means of the at least one stereo camera, and
representing predetermined working positions and detected actual tool positions and/or actual tool inclinations of the tool of the at least one construction machine in the virtual digital 3D terrain model.

In the following, the invention will be explained with reference to the accompanying drawings on the basis of an exemplary embodiment, in which:

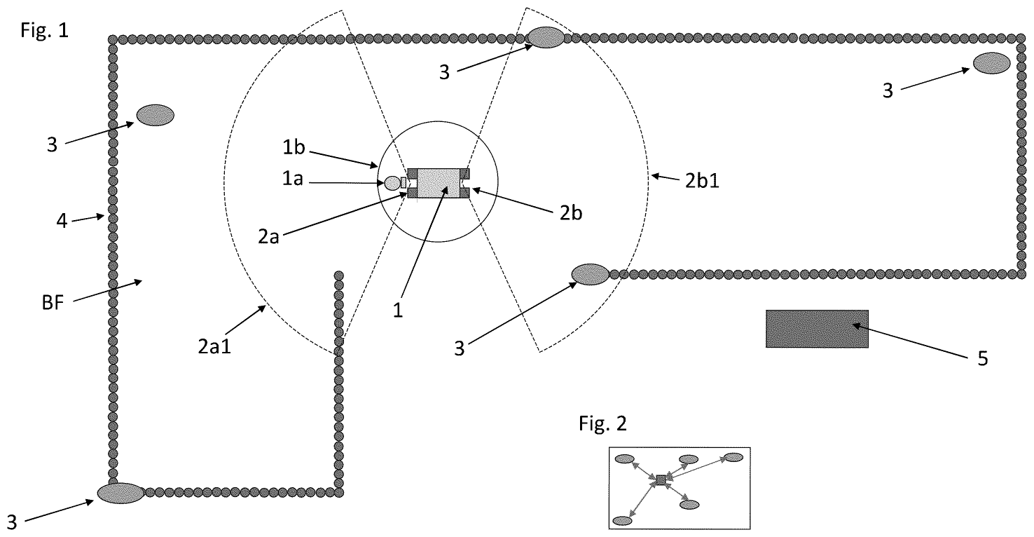

FIG. 1 is a schematic view of a construction area for explaining the method according to the invention; and

FIG. 2 is a schematic view of the relationship between a construction machine or construction equipment respectively and a plurality of reference points for determining the orientation and position of the construction machine/the construction equipment by measuring the distance to the reference points on the basis of stereoscopy.

The method, shown highly schematically in FIGS. 1 and 2, for determining the position and/or orientation of tools 1a of construction machines 1 in a construction area BF, in which, shown here by way of example, an overlapped bored pile wall 4 is intended to be produced by means of numerous aligned and each other partially overlapping bored piles using a tool in the form of drilling equipment or a drill pipe 1a, first comprises providing at least one reference point 3, the position of which is known relative to a predefined 3D world coordinate system.

This reference point 3 acts as a distinctive, calibrated object in the construction area as a reference for further location. The position of the reference point 3 can be determined by a surveyor, optionally also using satellite signals. Since it is sufficient to determine the position within the 3D world coordinate system once, a potentially more complex process can also be accepted for this purpose than for permanent position determination by means of simple navigation equipment.

According to the invention, at least one stereo camera 2a; 2b is then attached to at least one construction machine 1 or to a movable carrier, such that the stereo camera can detect at least one detection region 2a1; 2b1 within the construction area BF, preferably a working region 1b of the construction machine 1, and such that the at least one reference point 3 can be recognised in the images of the stereo camera of the detection region 2a1; 2b1. It may be sufficient here for the reference point 3 to be able to be detected at least in a rotational position of the construction machine, which can be a mobile construction machine in the form of a civil engineering machine comprising a movable undercarriage and a superstructure that is rotatable relative thereto.

Since the visibility and the distance of the reference point from the civil engineering machine may also fall within a region in which positioning is not possible to this point, a plurality of reference points 3 are preferably arranged to be distributed over the construction area BF for complete detection of the entire construction area by means of the stereo camera(s).

The at least one stereo camera is preferably attached to the construction machine such that its detection region 2a1; 2b1 detects a relevant region of the construction area including at least one reference point 3. To do this, the stereo camera can be mounted on a rotatable superstructure or on a mast or another exposed component of the construction machine where the detection region is not impaired or is hardly impaired at all by the construction machine itself or by objects in the immediate working region 1b. Owing to the rotation of the superstructure during the working process at a working point and owing to the movement of the construction machine to another working point, the detection region 2a1; 2b1 of the stereo camera is permanently moved and the detected portion of the construction area around the construction machine is extended.

Since the at least one reference point 3 can be recognised in the images of the stereo camera of the detection region 2a1; 2b1, the stereo camera can accurately reproduce the distance to this point. Because the location at which it is attached to the construction machine is known, the orientation of the superstructure and the position of the civil engineering machine can thus be deduced. After moving the construction machine or the civil engineering machine respectively, the reference point 3 is detected from a different viewing angle.

By calibrating the at least one stereo camera 2a; 2b on the basis of the detection of the at least one reference point 3 and triangulation, a transformation between the 3D world coordinate system and a 2D image coordinate system of the at least one stereo camera 2a; 2b can be ascertained in a manner known per se.

Likewise in a manner known per se, a virtual digital 3D terrain model of the construction area BF can then be prepared after calibrating by means of digital image processing (stereoscopy) and image recognition on the basis of the detection of the construction area BF by means of the at least one stereo camera 2a; 2b.

By the camera images of the same detection portion or different detection portions which are detected over a longer period of time continually being offset against one another, over time, not only can a region of 360° immediately around the construction machine be detected, but the entire construction area can be detected and imaged in the virtual digital 3D terrain model.

The intermittently or continuously repeated detection of already detected sections of the construction area BF by means of the at least one stereo camera 2a; 2b, preferably while its position or orientation is being changed or after it has been changed and then has another detection region 2a1; 2b1, and the continual expansion and update/alignment of the virtual digital 3D terrain model by means of digital image processing (stereoscopy) and image recognition on the basis of the repeated detection of the construction area BF by means of the at least one stereo camera 2a; 2b continuously improves the coverage and the accuracy of the virtual digital 3D terrain model.

To improve the coverage and the accuracy of the virtual digital 3D terrain model, at least one further stereo camera 2a; 2b can be provided and arranged such that it detects a region of the construction area BF that is at least partially differs from the detection region 2a1; 2b1 of the at least one stereo camera 2a; 2b and preferably the at least one reference point 3 and/or one or more further reference points 3. This/these further stereo camera(s) can be calibrated on the basis of the detection of the at least one reference point and/or on the basis of the one or further reference points 3 by triangulation in order to ascertain the transformation between the 3D world coordinate system and the 2D image coordinate system of the at least one further stereo camera 2a; 2b. By incorporating the detection of the construction area BF by the at least one further stereo camera 2a; 2b in the virtual 3D terrain model of the construction area BF by digital image processing (stereoscopy) and image recognition, portions of the construction area are detected at different angles, such that, even if the stereo cameras are not pivoted across wide regions and/or their respective detection regions are limited, extensive coverage of the construction area can be obtained.

To improve the accuracy of the virtual digital 3D terrain model, further influencing factors, for example a position of the sun or a wind direction, can also be detected by means of corresponding sensors and such further influencing factors can be taken into account when preparing and/or updating/aligning the virtual digital 3D terrain model.

Predetermined working positions (e.g. target drilling points or starting points) and actual tool positions and/or actual tool inclinations of the tool 1a of the at least one construction machine 1 in the virtual 3D terrain model and having been detected by the stereo camera/stereo cameras, can be represented on the basis of the virtual digital 3D terrain model, optionally once a minimum accuracy to be predetermined is reached.

Once a predetermined accuracy of the virtual digital 3D terrain model is reached, the detection frequency by the stereo camera(s) and the with it associated computational effort can of course be reduced.

The representation in the virtual digital 3D terrain model can then be used as a basis for the positioning and orientation of the tool 1a of the at least one construction machine 1 in order to bring target and actual values into match.

In particular, by means of the images of the stereo camera(s), starting points of special civil-engineering elements (for example piles or panels, etc.) can be identified, wherein, by using a plurality of stereo cameras, the X, Y and Z coordinates of the starting point as well as a possible orientation can also be detected for non-rotationally symmetrical elements.

As a result, alignment between the actual starting points and the digital site plan can be prepared automatically and without manual intervention by persons. For example, an automatic comparison of dimensions of the elements can also be made in order to verify a correct drilling diameter, for example. Lastly, element IDs can also be automatically assigned between the digital site plan and the actual construction execution and this can be communicated in an up-to-date manner (“now drilling is carried out at pile 13”) and/or can be documented and evaluated in another way, for example for determining the construction progress.

On the basis of the alignment of the digital site plan of the construction area with the virtual digital 3D terrain model of the construction area prepared on the basis of the image detection, position deviations can thus on the one hand be identified and, on the other hand, the results of the alignment can also be stored for the purposes of documenting the working process and/or, at least in the event of position deviations, can also be used for correcting the positioning of a/the tool of a/the construction machine. Once a construction machine is located in the construction area, it can of course also be recalibrated/located at already produced distinctive construction elements having a known position.

For example, for the further location within the construction area, a machine coordinate system of a/the construction machine 1 or a/the tool 1a or a local coordinate system can be derived from the virtual 3D terrain model and the derived machine coordinate system can be used for locally determining the position and/or orientation of the construction machine 1 or the tool 1a within the construction area BF, without recourse to an current position determination by means of satellite signals or a manual calibration process.

The invention also relates to a system for determining the position and/or orientation of tools 1a of construction machines 1 in a construction area BF, in particular according to the method according to the invention. The system comprises at least one stereo camera 2a; 2b, which is attached to at least one construction machine 1 or to a movable carrier, such that the stereo camera can detect at least one detection region 2a1; 2b1 within the construction area BF, preferably a working region of the construction machine 1, at least one reference point 3, the position of which is known relative to a predefined 3D world coordinate system and which can be recognised in the images of the stereo camera, in the detection region 2a1; 2b1 of the at least one stereo camera 2a; 2b, and an apparatus configured to carry out the above-described steps of the method. The apparatus can for example be housed in a site container 5 in or at the construction area BF, wherein the signals of the stereo camera(s) 2a; 2b can be transmitted to the apparatus using a wireless transmission protocol. The same also applies to the transmission of data generated by the apparatus (for control and/or display) to the construction machine(s) in the construction area.

1. A method for determining the position and/or orientation of tools of construction machines in a construction area), comprising
attaching at least one stereo camera to at least one construction machine or to a movable carrier, such that the stereo camera can detect at least one detection region within the construction area, preferably a working region of the construction machine,
providing at least one reference point, the position of which is known relative to a predefined 3D world coordinate system and which can be recognised in the images from the stereo camera, in the detection region of the at least one stereo camera,
calibrating the at least one stereo camera on the basis of the detection of the at least one reference point and triangulation in order to ascertain a transformation between the 3D world coordinate system and a 2D image coordinate system of the at least one stereo camera,
preparing a virtual digital 3D terrain model of the construction area by means of digital image processing, in particular stereoscopy, and image recognition on the basis of the detection of the construction area by means of the at least one stereo camera, and
representing predetermined working positions and detected actual tool positions and/or actual tool inclinations of the tool of the at least one construction machine in the virtual digital 3D terrain model.

2. The method according to claim 1, comprising
positioning and/or orienting the tool of the at least one construction machine on the basis of the virtual digital 3D terrain model in order to bring target and actual values into match.

3. The method according to claim 1, comprising
repeating (intermittently or continuously) the detection of the construction area by means of the at least one stereo camera, preferably while it is being moved or after it has been moved and has another detection region, and continually expanding and updating/aligning the virtual 3D terrain model by means of digital image processing (stereoscopy) and image recognition on the basis of the repeated detection of the construction area by means of the at least one stereo camera.

4. The method according to claim 1, comprising
providing at least one further stereo camera, which is arranged such that it detects a region of the construction area that differs or at least partially differs from the detection region of the at least one stereo camera and preferably the at least one reference point and/or a further reference point,
calibrating the at least one further stereo camera on the basis of the detection of the at least one and/or further reference point and triangulation in order to ascertain the transformation between the 3D world coordinate system and the 2D image coordinate system of the at least one further stereo camera, and incorporating the detection of the construction area by the at least one further stereo camera in the virtual 3D terrain model of the construction area by digital image processing (stereoscopy) and image recognition.

5. The method according to claim 1, comprising
ascertaining further influencing factors, for example a position of the sun or a wind direction and taking them into account when preparing and/or updating/aligning the virtual (digital) 3D terrain model.

6. The method according to claim 1, comprising
deriving a machine coordinate system of a/the construction machine or a/the tool or a local coordinate system from the virtual 3D terrain model and using the derived machine coordinate system for locally determining the position and/or orientation of the construction machine or the tool within the construction area.

7. The method according to claim 1, comprising
aligning a digital site plan of the construction area with the virtual 3D terrain model of the construction area and identifying position deviations.

8. The method according to claim 7, comprising
storing the result of the alignment for the purposes of documenting the working process.

9. The method according to claim 7, comprising
using the result of the alignment in the event of position deviations for correcting the positioning of a/the tool of a/the construction machine.

10. A system for determining the position and/or orientation of tools of construction machines in a construction area, in particular according to the method according to claim 1, comprising:
at least one stereo camera, which is attached to at least one construction machine or to a movable carrier, such that the stereo camera can detect at least one detection region within the construction area, preferably a working region of the construction machine,
at least one reference point, the position of which is known relative to a predefined 3D world coordinate system and which can be recognised in the images of the stereo camera, in the detection region of the at least one stereo camera, and
an apparatus configured to carry out the following steps of the method:
calibrating the at least one stereo camera on the basis of the detection of the at least one reference point and triangulation in order to ascertain a transformation between the 3D world coordinate system and a 2D image coordinate system of the at least one stereo camera,
preparing a virtual digital 3D terrain model of the construction area by means of digital image processing, in particular stereoscopy, and image recognition on the basis of the detection of the construction area by means of the at least one stereo camera, and
representing predetermined working positions and detected actual tool positions and/or actual tool inclinations of the tool of the at least one construction machine in the virtual digital 3D terrain model.
